(19) United States
(12) Patent Application Publication
(10) Pub. No.: US 2004/0022692 A1
(43) Pub. Date: Feb. 5, 2004

(54) Microcompartment array with high compartment density and process for producing the same

(75) Inventors: Eugen Ermantraut, Jena (DE); Johann Michael Kohler, Golmsdorf (DE); Gunter Mayer, Jena (DE); Klaus Wohlfart, Laasan (DE)

Correspondence Address: JORDAN AND HAMBURG LLP, 122 EAST 42ND STREET, SUITE 4000, NEW YORK, NY, 10168, US

(73) Assignee: Institut fuer Physikalische Hochtechnologie e.V., Jena (DE)

(21) Appl. No.: 10/631,445

(22) Filed: Jul. 31, 2003

Related U.S. Application Data
(62) Division of application No. 09/355,442, filed on Jul. 28, 1999, now abandoned.
Application No. 09/355,442 is a 371 of international application No. PCT/EP98/00835, filed on Feb. 13, 1998.

(30) Foreign Application Priority Data
Feb. 15, 1997 (DE) 197 05 910.4

(51) Int. Cl. B01L 3/00

(52) U.S. Cl. 422/102

(57) ABSTRACT

A microcompartment array with a high compartment density and a process for producing the same are disclosed. To solve the problem that consists in arranging as many compartments as possible per surface unit and in providing a process for producing the same which excludes any mixture of adjacent compartment contents even when the compartments are overfilled, without having to change the way in which the compartments are filled, a first functional surface lining is applied on the inner walls of the compartment-like recesses, whereas the support surface areas which separate the individual compartment-like recesses from each other by their open sides are provided with a second functional surface lining having an effect opposite to that of the first functional surface lining.

### BACKGROUND OF THE INVENTION

The invention relates to a microcompartment array of a high compartment density. Arrays of micro-chambers of single chamber volumes in the sub-microliter range are used in biotechnology, in the agent screening, and in the combinatoric chemistry for a parallel and automated handling of low amounts of liquids.

There are arrays of cavities known and methods for manufacturing the same which are made on the basis of synthetic resin (JP 2-95258; JP 2-35360) or on the basis of hydrophobic polymers which were subjected to a selective plasma treatment (U.S. Pat. No. 5,041,266; U.S. Pat. No. 5,229,163; U.S. Pat. No. 4,741,619). In the DE 42 09 064 A1 the recesses for the cavities are manufactured by simple mechanical boring in a Teflon substrate. The major disadvantage of this group of arrays of cavities consists in that, with respect to the present invention, only recesses which are spaced apart from one another by comparatively large distances can be manufacturer with the presently known techniques and in that said arrays of cavities cannot be autoclaved and, hence, are disposable articles.

Furthermore, the manufacture of micromechanical structures and cavities in semiconductive material or in glass by wetchemical etching (DE 39 15 920 A1) or by dry-etching techniques in combination with photolithographic steps (U.S. Pat. No. 5,462,839) is described. In “Microchemical Compartments for Biotechnological Applications: Fabrication and Investigation of Liquid Evaporation, Proc. of Eurosensors X, Vol. 2, Leuven, Belgium, September 1996” G. Mayer, J. M. Köhler describe micro-compartments in the submicroliter range made from silicon wafers into which a plurality of recesses is inserted by means of suitable masking methods and anisotropic wetchemical etching techniques. Said compartments are, depending on the application selected, filled with liquids, in particular, aqueous solutions by means of micropipettes. The latter group of microarrays described involve the danger that a cross-over of the individual compartment contents into adjacent compartments is feasible. Since there is, due to the low compartment volume and the considerable evaporation losses resulting therefrom, the effort to work under a saturated steam atmosphere, the probability of an cross-over is additionally increased, for example, due to steam condensations in the areas between the compartments. In order to substantially eliminate the danger of contamination and a possible mixing of the contents of the compartments, respectively, as far as possible the prior art only offers the feasibility to have the compartments sufficiently spaced apart from one another which reduces the number of compartments per given area.

It is an object of the present invention to provide a microcompartment array of the highest possible number of compartments per area and a method for the manufacture of the same, wherein a crossover of adjacent compartment contents is eliminated even at an overfill of the compartments without the necessity to change the kind of filling the compartments.

The object is realized by the features of the claims 1 and 5. Advantageous further embodiments are covered by the dependent claims.

### SUMMARY OF THE INVENTION

The very essence of the invention consists in that in a base, which is to be employed as a microcompartment array, and which is provided with a plurality of recesses, the base surface ranges which space apart from one another the individual compartment-like recesses in the open compartment side are provided with a functional group which acts against the surface covering of the interior wall regions of the compartments. When aqueous solutions are used said base surface ranges are provided with a hydrophobic property, whereas the interior wall regions of the compartments have to exhibit a hydrophilic property. Within the scope of the invention, the application of the desired surface covering of the said base surface ranges is obtained in that said ranges are at least once contactingly captured by a non-profiled elastomeric body which is provided with an agent carrying or effecting a functional surface covering.

Furthermore, it lies within the scope of the invention that, for example, the wetting behavior or the crossover behavior with aqueous solutions has to be obtained by insertion of hydrophilic surface coverings in the range of the interior compartment walls such as surfaces being rich in OH-groups, sulphonic acid groups, or carboxyl groups, and to realize the second functional surface covering, which has to be effected by means of an elastomeric body and which has to eliminate a crossover between the compartments, by alkoxy groups, fluoralkane groups, fluoraryl groups, oxyaryl groups, alkoxysilane or alkyl- or arylsiloxane.

### DETAILED DESCRIPTION OF THE INVENTION

The invention will be described hereinafter in more detail by reference to the, schematical drawings and by virtue of one embodiment. There is shown in:

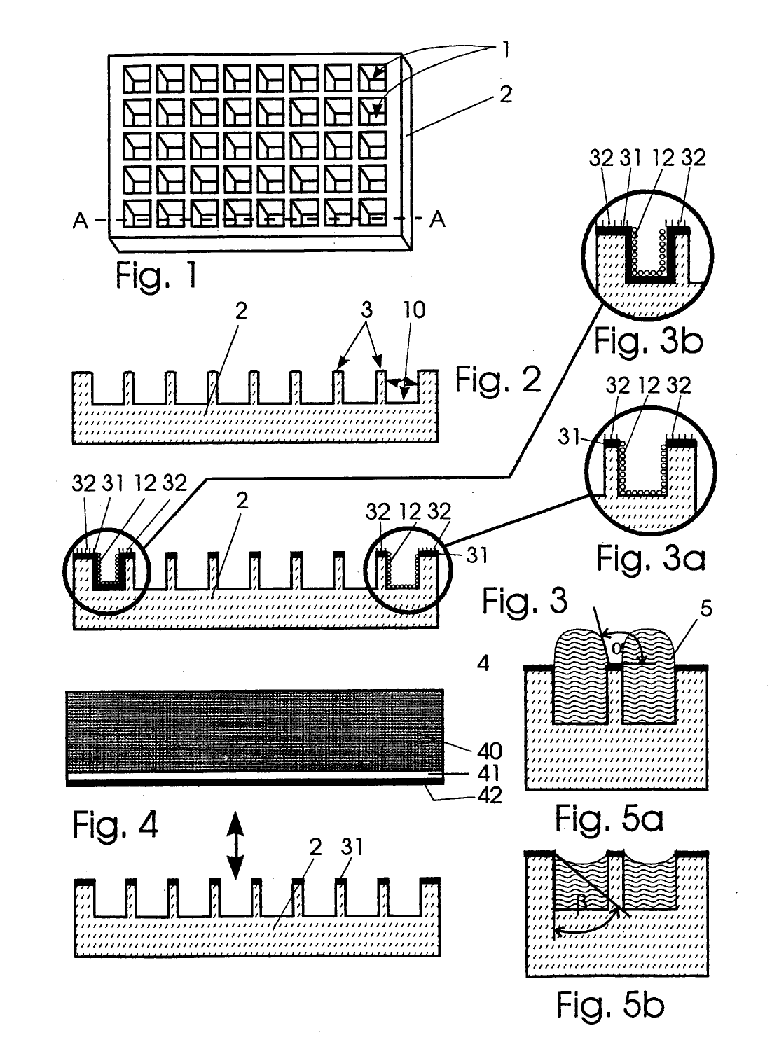

FIG. 1 an example of a microcompartment array,

FIG. 2 a partial sectional plane of the microcompartment array along the line A-A according to FIG. 1,

FIG. 3 a special surface embodiment of the microcompartment array ready to produce a hydrophobic surface covering,

FIGS. 3a and 3b each a modification of an embodiment according to FIG. 3,

FIG. 4 indicated, the generation of a hydrophobic surface covering,

FIG. 5a two adjacent overfilled individual compartments of a microcompartment array, and

FIG. 5b two adjacent properly filled individual compartments of a microcompartment array.

In FIG. 1 a microcompartment array is shown, comprising a base 2 which, in the present example, is made of silicon and can be part of a conventional silicon wafer. The microcompartment array is provided with a plurality of recesses 1. Practical dimensions of the recesses lie in an order of size of 800 μm-800 μm at a volume of 140 nl, and the microcompartment array comprises more than one hundred of such recesses per cm² in the present case. It is also feasible to produce microcompartment arrays with compartment volumes in an order of size of 20 nl whereby 400 of such recesses per cm² are obtainable. FIG. 2 shows a part of a sectional plane of the microcompartment array according to FIG. 1, the line of section running along a line A-A. In the present example the microcompartment array is at first coated with a gold coat 31 of about 50 . . . 100 nm thickness on its entire surface by means of conventional sputtering methods, wherein in FIG. 3 only the gold coat of the surfaces 3 of the partition ranges are shown. Furthermore, a further silicon wafer 40 is provided with an elastomeric coat 41 which, advantageously, is formed by spin-coated polydimethylsiloxane which after spinning is cured. A thin layer 42 of a material selected from a functional group, in the present case in the form of a thio-functional alkane (5% in ethanol), such as hexadecylmercaptan, is applied upon the silicon elastomeric layer 41. Subsequently, the non-profiled silicon die 4 activated in the foregoing manner is deposited upon the surface of the microcompartment array, as indicated by the double arrow in FIG. 4. In this way the formation of a chemically very stable gold-thiol-link is obtained on the surface 3 of the partitions which space apart the open individual compartments 1, thereafter the die 4 is removed. The monomolecular layer 32 of a thioalkane which is formed on the ranges 3 of the microcompartment arrays only modifies said ranges whereas the interior walls 10 of the compartments remain non-affected, in the present example as pure gold surfaces (not shown).

In a further subsequent step the thin gold coat remaining at the interior walls of the compartments can be removed by selective etching without attacking the surface ranges 32 modified by the thioalkane layer (compare FIG. 3a). A suitable etching means for that purpose is a 0.1 M KCN-solution with 0.001 M K₃Fe(CN)₆ as an oxidizing agent. The etching time lies under 1 min. for a gold coat of, for example, 50 nm thickness.

The last described further subsequent step can also be carried out in such a manner that the gold coat 31 remaining on the internal walls of the compartments is not selectively removed. It is, however, modified by a further selective reaction with a further thio-functional group, for example, thioglycerine, whereby the thioglycerine binds to the bright gold coated internal walls of the compartments under formation of a layer 12, but does not bind to the gold coated surface ranges 32 modified by thioalkane, indicated in a part of a sectional view in FIG. 3b. Thereby the internal walls of the compartments are provided with hydrophilic properties and the wetting behavior even more enhanced relative to the hydrophobic external ranges.

When the microcompartment array is filled with aqueous solutions, as indicated in the partial sectional view of FIGS. 5a and 5b the formed thioalkane layer has a strong hydrophobic effect, whereas the surfaces 10 of the internal walls of the compartments are of hydrophilic behavior. This results in that even at an overfill of the individual compartments with almost double the compartment volume (refer to FIG. 5a) a trop-shaped overhang 5 formation takes a wetting angle α of >90° without that a crossover of the liquids between adjacent individual compartments results. In the case of a normal filling, in the example according to FIG. 5b, a wetting angle β of >30° results.

The invention is not restricted to the disclosed embodiments. In particular, when non-aqueous solutions are used such as, for example, ethanol, toluol, or acetonitril it is decisive within the frame of the invention to render the wetting behavior of said surface ranges 3 distinctly different relative to the wetting behavior of the internal wall ranges of the compartments which is achieved by a suitable selection of the different first and second functional groups, wherein with respect to the first functional groups non-wetting materials are eligible then, such as alkane and silane, and wherein with respect to the second functional groups wetting materials are eligible, such as glycerine, alcohol, carboxylic acids, or ester and wherein the application of the second functional group is achieved by means of said elastomeric die 4. Also the exemplified embodiment of the elastomeric die as a plane non-profiled plate has not to be considered as a restriction of the invention thereto. It is also feasible to employ a plate curved in one dimension or to use a cylindrical body which carries the second functional group and which covers by rolling the desired surface ranges 3 of the microcompartment array.

1. Microcompartment array comprising a base (2) being provided with a plurality of compartment-like recesses (1), characterized in that the interior walls (10) of the compartments of the compartment-like recesses (1) are provided with a first functional surface covering, whereas at least the basis surface ranges (3), which space apart the individual compartment-like recesses (1) from one another on the open compartment side, are provided with a second functional surface covering (32) which, in its effect, is opposing said first functional surface covering.

2. Microcompartment array as claimed in claim 1, characterized in that a silicon wafer is employed for the base (2) being provided with a plurality of compartment-like recesses (1), wherein said first functional surface covering exhibits a hydrophilic property and said second functional surface covering (32) exhibits a hydrophobic property.

3. Microcompartment array as claimed in claim 2, characterized in that the hydrophobic surface ranges (30) are formed by a gold coat (31) attached to the silicon surface ranges (3), said gold coat (31) is provided with a monomolecular thioalkane surface covering (32).

4. Microcompartment array as claimed in claims 2 and 3, characterized in that the interior walls (10) of the compartments are also provided with a gold coat (31), subjected to a surface modification with a further thio-functional group which does not affect said monomolecular thioalkane surface covering (32).

5. Microcompartment array as claimed in claims 1 or 2, characterized in that said first functional surface covering exhibiting a hydrophilic property is constituted by a surface being rich in OH-groups, sulphonic acid groups, or carboxyl-groups, and said second functional surface covering (32) by alkoxy-groups, fluoralkane-groups, fluoraryl-groups, oxyaryl-groups, alkoxysilane or alkyl- or arylsiloxane.

6. Method for manufacturing microcompartment arrays, characterized in that a base (2) being provided with a plurality of compartment-like recesses (1) in the surface ranges (3), which space apart the individual compartment-like recesses (1) from one another on the open compartment side, is at least once contactingly captured by a non-profiled elastomeric body (4) which is provided with an agent carrying or effecting a second functional surface covering.

7. Method for manufacturing microcompartment arrays as claimed in claim 6, characterized in that, when employing silicon for a base, at least the surface ranges (3), which space apart the individual compartment-like recesses (1) from one another on the open compartment side, are coated with a thin gold coat (31) and said thin gold coat ranges are subjected to the contacting effect of an elastomeric body (4) which, at its surface being in opposition to said thin gold coat ranges (31) is provided with a thio-functional alkane (42).

8. Method for manufacturing microcompartment arrays as claimed in claim 7, characterized in that the remaining gold coat on the interior walls of the compartments is modified by a selective reaction with a further thio-functional group.
